(19) United States
(12) Patent Application Publication
(10) Pub. No.: US 2026/0356353 A1
(43) Pub. Date: Nov. 12, 2026

(54) VEHICLE PARKING

(71) Applicant: Ford Global Technologies, LLC, Dearborn, MI (US)

(72) Inventors: Matt Jones, Beaverton, OR (US); Justin Miller, Berkley, MI (US); Friederike Philipsenburg, Canton, MI (US); Joshua Wheeler, Trenton, MI (US)

(73) Assignee: Ford Global Technologies, LLC, Dearborn, MI (US)

(21) Appl. No.: 19/199,524

(22) Filed: May 6, 2025

(51) Int. Cl. B60W 30/06

(52) U.S. Cl. CPC B60W 30/06; B60W 2540/01; B60W 2540/049; B60W 2540/227; B60W 2552/50; B60W 2556/10

(57) ABSTRACT

A computer includes a processor and a memory, and the memory stores instructions executable by the processor to, upon receiving a command to park a vehicle in a parking space, determine a target parking pose in the parking space based on a stored preference of an operator of the vehicle from a previous trip of the vehicle; and actuate components of the vehicle according to an autonomous parking feature of the vehicle to navigate the vehicle to the target parking pose. The target parking pose is defined relative to a default parking pose in the parking space.

### BACKGROUND

Advanced driver assistance systems (ADAS) are electronic technologies that assist drivers in driving functions. Examples of ADAS include forward proximity detection, lane-departure detection, blind-spot detection, braking actuation, adaptive cruise control, and lane-keeping assistance systems.

### BRIEF DESCRIPTION OF THE DRAWINGS

FIG. 1 is a block diagram of an example vehicle.

FIG. 2 is a top view of the vehicle with a passenger compartment exposed for illustration.

FIG. 3A is a top diagrammatic view of an example of the vehicle parking in a parking space at a default parking pose in the left pane and at a target parking pose in the right pane.

FIG. 3B is a top diagrammatic view of another example of the vehicle parking in the parking space at the default parking pose in the left pane and at the target parking pose in the right pane.

FIG. 3C is a top diagrammatic view of another example of the vehicle parking in the parking space at the default parking pose in the left pane and at the target parking pose in the right pane.

FIG. 3D is a top diagrammatic view of another example of the vehicle parking in the parking space at the default parking pose in the left pane and at the target parking pose in the right pane.

FIG. 3E is a top diagrammatic view of another example of the vehicle parking in the parking space at the default parking pose in the left pane and at the target parking pose in the right pane.

FIG. 4 is a flowchart of an example process for parking the vehicle in the parking space.

### DETAILED DESCRIPTION

This disclosure provides techniques for operation of an autonomous parking feature of a vehicle. When activated, an autonomous parking feature may actuate propulsion, braking, and steering of the vehicle to navigate the vehicle into a parking space. The autonomous parking feature may be a standalone advanced driver assistance system (ADAS); in other words, an operator may manually drive the vehicle close to the parking space and then activate the autonomous parking feature to park the vehicle in the parking space. Alternatively, the autonomous parking feature may be part of autonomous or semi-autonomous operation of the vehicle that also operates in situations other than parking.

A computer of the vehicle is programmed to, upon receiving a command to park a vehicle in a parking space, determine a target parking pose in the parking space. The target parking pose is defined relative to a default parking pose in the parking space. The target and default parking poses may define a spatial location and orientation of the vehicle relative to the parking space. For example, the default parking pose may include that the vehicle is oriented front-first in the parking space or laterally centered in the parking space, and the target parking pose may include that the vehicle is oriented rear-first in the parking space (e.g., driven in reverse into the parking space) or laterally biased to the left or right in the parking space.

The computer determines the target parking pose based on a stored preference of an operator of the vehicle from a previous trip of the vehicle. The stored preference may specify a target parking pose associated with a specific context (e.g., location and time of day, occupancy status of the vehicle, etc.). For example, when the vehicle is at an operator's office parking lot at approximately 9:00 AM, the target parking pose may be laterally offset to provide additional room on a driver's side of the vehicle. During the previous trip of the vehicle, the operator may have directly inputted the stored preference into the computer, or the computer may have learned the stored preference from how the operator manually parks the vehicle. Once the computer determines the target parking pose, the computer actuates components of the vehicle (e.g., propulsion, braking, and steering) according to the autonomous parking feature to navigate the vehicle to the target parking pose.

A computer includes a processor and a memory, and the memory stores instructions executable by the processor to, upon receiving a command to park a vehicle in a parking space, determine a target parking pose in the parking space based on a stored preference of an operator of the vehicle from a previous trip of the vehicle; and actuate components of the vehicle according to an autonomous parking feature of the vehicle to navigate the vehicle to the target parking pose. The target parking pose is defined relative to a default parking pose in the parking space.

In an example, the instructions to determine the target parking pose may include instructions to determine the target parking pose based on a current time or a current geographic location of the vehicle.

In an example, the stored preference may be paired with a stored time, and the instructions to determine the target parking pose may include instructions to determine the target parking pose according to the stored preference that is paired with the stored time matching a current time.

In an example, the stored preference may be paired with a stored geographic location, and the instructions to determine the target parking pose may include instructions to determine the target parking pose according to the stored preference that is paired with the stored geographic location matching a current geographic location.

In an example, the instructions to determine the target parking pose may include instructions to determine the target parking pose based on an occupancy status of the vehicle.

In an example, the instructions to determine the target parking pose may include instructions to determine the target parking pose based on which seats of the vehicle are occupied.

In an example, the instructions to determine the target parking pose may include instructions to determine the target parking pose based on whether a seat of the vehicle is occupied by a child in a child seat or a full-size occupant.

In an example, the instructions to determine the target parking pose may include instructions to determine the target parking pose based on a proximity of an object to the parking space. In a further example, the object may be a fixed barrier adjacent to the parking space.

In another further example, the object may be a second vehicle parked in a second parking space adjacent to the parking space.

In an example, the parking space may be a perpendicular parking space, the default parking pose may include the vehicle being laterally centered in the parking space, and the target parking pose may include the vehicle being laterally shifted by a lateral offset from the default parking pose. In a further example, the instructions to determine the target parking pose may include instructions to determine a direction of the lateral offset.

In another further example, the instructions to determine the target parking pose may include instructions to determine a magnitude of the lateral offset.

In an example, the default parking pose may include the vehicle being parked in a front-first direction in the parking space, and the instructions to determine the target parking pose may include instructions to determine an orientation of the vehicle in the parking space, the orientation being a selection of the front-first direction and a rear-first direction. In a further example, the autonomous parking feature may navigate the vehicle forward into the parking space upon the selection of the front-first direction, and the autonomous parking feature may navigate the vehicle in reverse into the parking space upon the selection of the rear-first direction.

A method includes, upon receiving a command to park a vehicle in a parking space, determining a target parking pose in the parking space based on a stored preference of an operator of the vehicle from a previous trip of the vehicle; and actuating components of the vehicle according to an autonomous parking feature of the vehicle to navigate the vehicle to the target parking pose. The target parking pose is defined relative to a default parking pose in the parking space.

In an example, determining the target parking pose may include determining the target parking pose based on a current time or a current geographic location of the vehicle.

In an example, the stored preference may be paired with a stored time, and determining the target parking pose may include determining the target parking pose according to the stored preference that is paired with the stored time matching a current time.

In an example, the stored preference may be paired with a stored geographic location, and determining the target parking pose may include determining the target parking pose according to the stored preference that is paired with the stored geographic location matching a current geographic location.

In an example, determining the target parking pose may include determining the target parking pose based on an occupancy status of the vehicle.

With reference to the Figures, wherein like numerals indicate like parts throughout the several views, a computer 105 includes a processor and a memory, and the memory stores instructions executable by the processor to, upon receiving a command to park a vehicle 100 in a parking space 305, determine a target parking pose 315 in the parking space 305 based on a stored preference of an operator of the vehicle 100 from a previous trip of the vehicle 100; and actuate components of the vehicle 100 according to an autonomous parking feature of the vehicle 100 to navigate the vehicle 100 to the target parking pose 315. The target parking pose 315 is defined relative to a default parking pose 320 in the parking space 305.

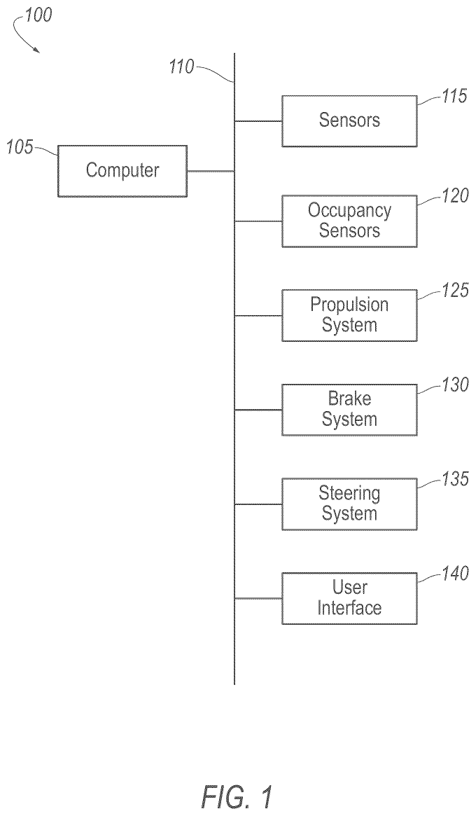

With reference to FIG. 1, the vehicle 100 may be any passenger or commercial automobile such as a car, a truck, a sport utility vehicle, a crossover, a van, a minivan, a taxi, a bus, etc. The vehicle 100 may include the computer 105, a communications network 110, sensors 115, occupancy sensors 120, a propulsion system 125, a brake system 130, a steering system 135, and a user interface 140.

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 110. The communications network 110 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the sensors 115, the occupancy sensors 120, the propulsion system 125, the brake system 130, the steering system 135, the user interface 140, and other components via the communications network 110.

The sensors 115 may provide data about operation of the vehicle 100, for example, wheel speed, wheel orientation, and engine and transmission data (e.g., temperature, fuel consumption, etc.). The sensors 115 may detect the location and/or orientation of the vehicle 100. For example, the sensors 115 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 115 may detect the external world, including objects and/or characteristics of surroundings of the vehicle 100, such as other vehicles 340, road lane markings, traffic lights and/or signs, road users, etc. For example, the sensors 115 may include radar sensors, ultrasonic sensors, scanning laser range finders, light detection and ranging (lidar) devices, and image processing sensors such as cameras.

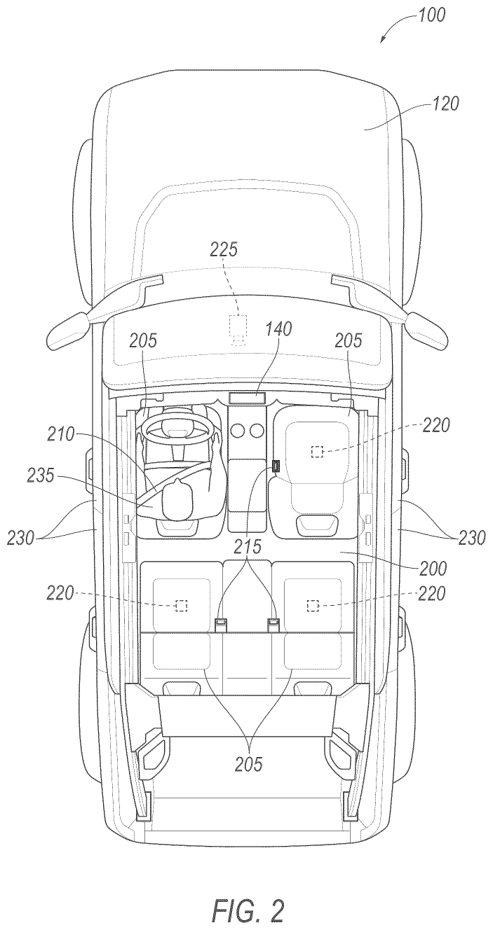

The occupancy sensors 120 are configured to detect occupancy of the seats 205. The occupancy sensors 120 may include buckle sensors 215, weight sensors 220, interior cameras 225, and/or other suitable sensors, as described in more detail with respect to FIG. 2.

The propulsion system 125 of the vehicle 100 generates energy and translates the energy into motion of the vehicle 100. The propulsion system 125 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 125 can include an electronic control unit (ECU) or the like that is in communication with and receives input from the computer 105 and/or a human operator. The human operator may control the propulsion system 125 via, for example, a pedal and/or a gear-shift lever.

The brake system 130 is typically a conventional vehicle braking subsystem and resists the motion of the vehicle 100 to thereby slow and/or stop the vehicle 100. The brake system 130 may include friction brakes such as disc brakes, drum brakes, band brakes, etc.; regenerative brakes; any other suitable type of brakes; or a combination. The brake system 130 can include an electronic control unit (ECU) or the like that is in communication with and receives input from the computer 105 and/or a human operator. The human operator may control the brake system 130 via, for example, a brake pedal.

The steering system 135 is typically a conventional vehicle steering subsystem and controls the turning of the wheels. The steering system 135 may be a rack-and-pinion system with electric power-assisted steering, a steer-by-wire system, as both are known, or any other suitable system. The steering system 135 can include an electronic control unit (ECU) or the like that is in communication with and receives input from the computer 105 and/or a human operator. The human operator may control the steering system 135 via, for example, a steering wheel.

The user interface 140 presents information to and receives information from an operator of the vehicle 100. The user interface 140 may be located on an instrument panel in a passenger compartment 200 of the vehicle 100, and/or wherever may be readily seen by the operator. The user interface 140 may include dials, digital readouts, screens, speakers, and so on for providing information to the operator, such as human-machine interface (HMI) elements such as are known. The user interface 140 may include buttons, knobs, keypads, microphone, and so on for receiving information from the operator.

With reference to FIG. 2, the vehicle 100 includes a passenger compartment 200 to house occupants 235, if any, of the vehicle 100. The passenger compartment 200 includes one or more seats 205 disposed in a front row of the passenger compartment 200 and one or more of the seats 205 disposed in a second row behind the front row. The passenger compartment 200 may also include seats 205 in a third row (not shown) at a rear of the passenger compartment 200. The seats 205 are shown to be bucket seats in the front row and bench seats in the second row, but the seats 205 may be other types. The position and orientation of the seats 205 and components thereof may be adjustable by an occupant 235.

The vehicle 100 includes a plurality of seatbelts 210 (e.g., one seatbelt 210 for each seat 205). The seatbelt 210 may be a three-point harness, meaning that webbing is attached at three points around the occupant 235 when buckled: an anchor, a retractor, and a buckle. The seatbelt 210 may, alternatively, include another number and/or arrangement of attachment points. The anchor may attach one end of the webbing to a frame of the seat 205. The other end of the webbing may feed into the retractor, which may include a spool that extends and retracts the webbing. A clip may slide freely along the webbing and, when engaged with the buckle, divide the webbing into a lap band and a shoulder band.

The occupancy sensors 120 may include at least one buckle sensor 215 (e.g., one buckle sensor 215 for each seatbelt 210). The buckle sensors 215 indicate whether the respective seatbelt 210 is latched (e.g., whether the clip is engaged with the buckle). The buckle sensors 215 may be any suitable type, such as electrical proximity sensors, electrical switches positioned to be closed when the respective seatbelts 210 are latched, etc.

The occupancy sensors 120 may include at least one weight sensor 220 (e.g., one weight sensor 220 for each seat 205). The weight sensors 220 indicate respective weights sitting in the respective seats 205. The weight sensors 220 may be any suitable type, such as an occupant classification system (OCS) (e.g., including a pressure sensor).

The occupancy sensors 120 may include the interior camera 225. The interior camera 225 can detect electromagnetic radiation in some range of wavelengths. For example, the interior camera 225 may detect visible light, infrared radiation, ultraviolet light, or some range of wavelengths including visible, infrared, and/or ultraviolet light. For example, the interior camera 225 can be a charge-coupled device (CCD), complementary metal oxide semiconductor (CMOS), or any other suitable type. The interior camera 225 may be fixed relative to the passenger compartment 200 of the vehicle 100. The interior camera 225 may be positioned inside the passenger compartment 200. The interior camera 225 may be positioned such that a field of view of the interior camera 225 encompasses the seats 205 (e.g., all the seats 205). Alternatively, coverage of all the seats 205 may be provided by multiple interior cameras 225.

For the purposes of this disclosure, “occupancy status” is defined as a classification of the vehicle 100 according to occupants 235 in the passenger compartment 200 of the vehicle 100. The classification may be according to presence, location, number, type, etc. of the occupants 235 in the passenger compartment 200. With respect to presence, the occupancy status specifies whether or not the passenger compartment 200 contains occupants 235. With respect to number, the occupancy status specifies how many occupants 235 are in the passenger compartment 200. With respect to location, the occupancy status specifies which seats 205 have occupants 235 and which do not. With respect to type, the occupancy status specifies whether an occupant in a seat 205 is a child 325 in a child seat 330 or a full-sized occupant 235.

The computer 105 may be programmed to determine the occupancy status of the vehicle 100. The computer 105 may determine the occupancy status based on data received from the occupancy sensors 120. For example, the computer 105 may determine that a seat 205 is occupied based on data from the respective buckle sensor 215 and/or weight sensor 220. The computer 105 may determine that a seat 205 is occupied upon receiving a value of a binary variable from the respective buckle sensor 215. The computer 105 may determine that a seat 205 is occupied upon receiving a weight value above a weight threshold from the respective weight sensor 220. The weight threshold may be chosen to be low enough that a large proportion (e.g., 99%) of a population of possible occupants 235 are heavier. For another example, the computer 105 may determine whether a seat 205 is occupied by a child 325 in a child seat 330 or by a full-sized occupant 235 based on data from the interior camera 225. The computer 105 may execute an object recognition algorithm applied to predetermined locations in the image frame at which occupants 235 of each seat 205 would be located if present.

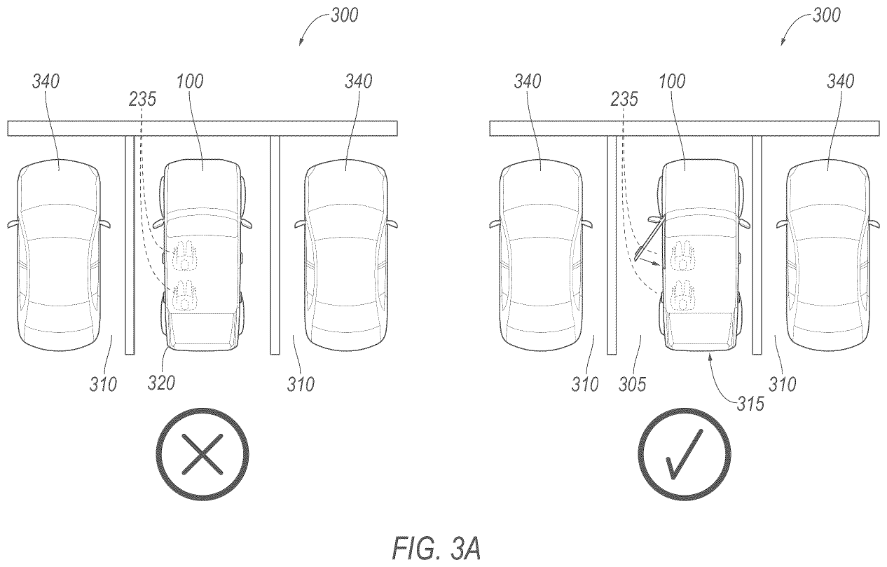

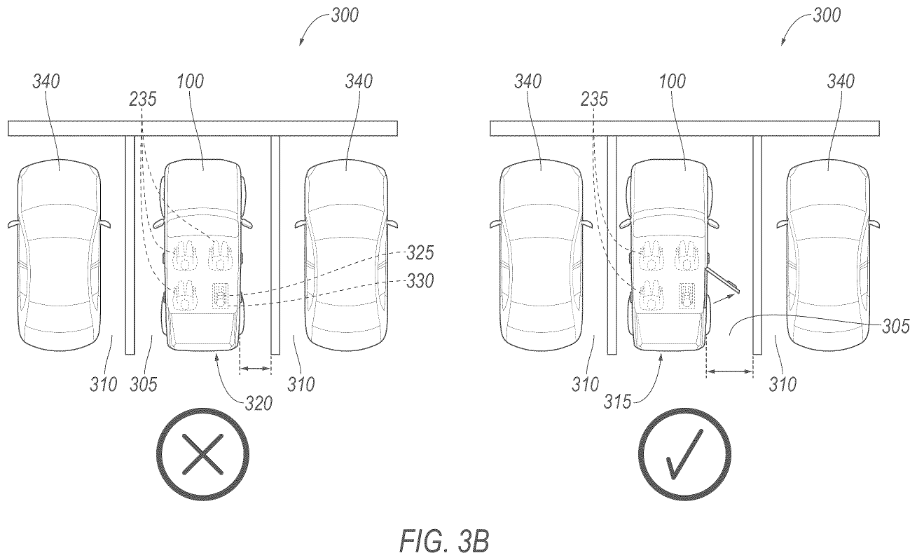

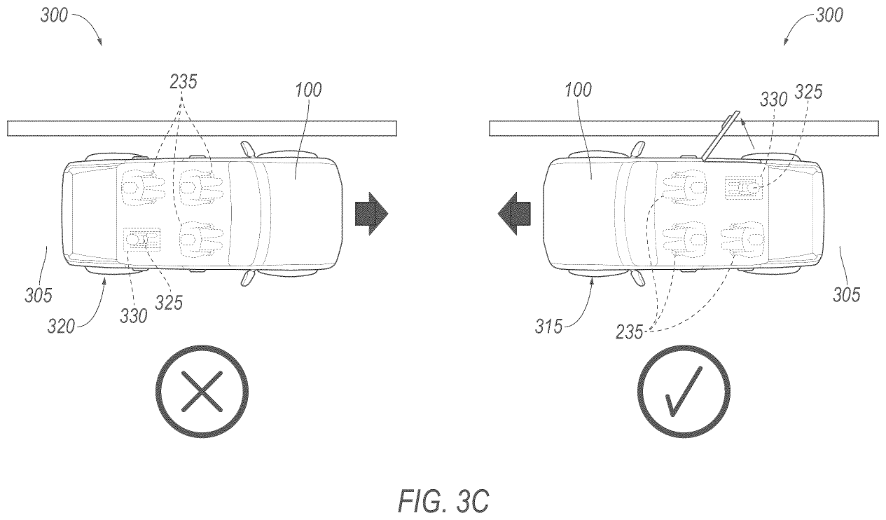

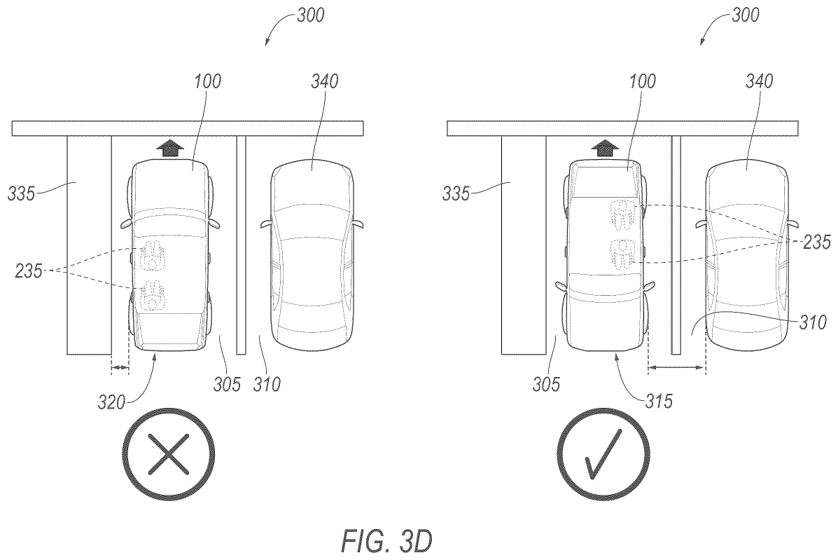

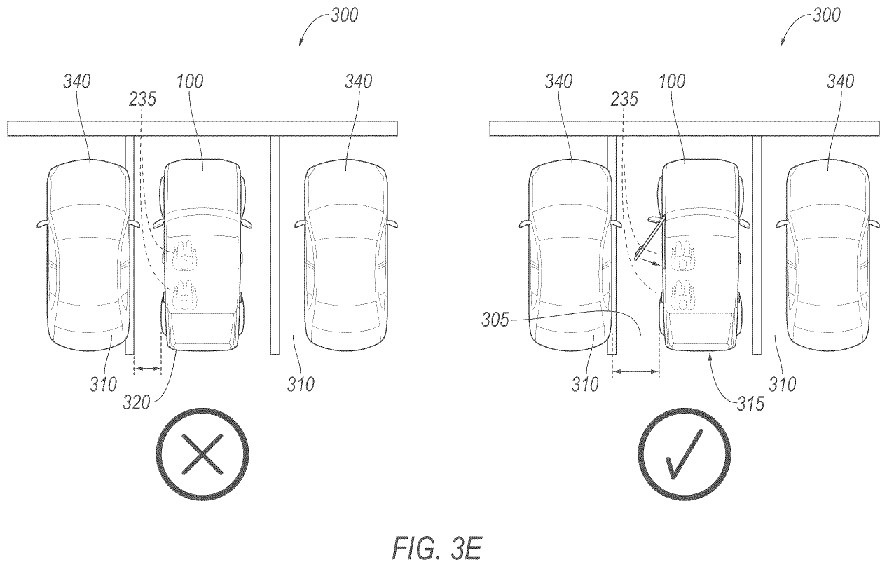

With reference to FIG. 3A-E, as a general overview, the computer 105 determines the target parking pose 315 in the parking space 305, and then actuates components of the vehicle 100 according to an autonomous parking feature of the vehicle 100 to navigate the vehicle 100 to the target parking pose 315.

For the purposes of this disclosure, a “parking space” is defined as an area designated for parking vehicles and sized for a single vehicle. The parking space 305 into which the vehicle 100 will be parked may be part of a larger parking area 300 containing multiple parking spaces 305, 310, such as a parking lot, parking garage, or parking zone (e.g., along the side of a street). The parking space 305 into which the vehicle 100 will be parked will be referred to herein as the first parking space 305, and other parking spaces as second parking spaces 310. The first parking space 305 may be either a perpendicular parking space (as shown in FIGS. 3A-B and 3D-E), a diagonal parking space, or a parallel parking space (as shown in FIG. 3C), as defined by a layout of the parking area 300.

The computer 105 may be programmed to identify the first parking space 305 (i.e., to identify the parking space 305 into which the vehicle 100 will be parked). For example, the computer 105 may identify a parking space 305 that is located at a preset position relative to the vehicle 100 when the autonomous parking feature is activated. For a perpendicular or diagonal parking space 305, the preset position may be a preset distance forward and a preset distance laterally (i.e., left or right) from the vehicle 100. For a parallel parking space 305, the preset position may be a preset distance rearward and a preset distance laterally from the vehicle 100. For another example, when the vehicle 100 is being driven autonomously in the parking area 300, the computer 105 may identify a parking space 305 according to a set of criteria, such as a closest parking space that is available (i.e., unoccupied).

The target parking pose 315 and default parking pose 320 define a final pose of the vehicle 100 relative to the parking space 305 upon parking in the parking space 305. For example, the parking poses 315, 320 may include a longitudinal dimension, a lateral dimension, and an orientation of the vehicle 100. The longitudinal dimension may define how far forward or rearward the vehicle 100 is relative to the parking space 305. The lateral dimension may define how far left or right the vehicle 100 is relative to the parking space 305. The orientation may be an angle between a forward direction of the vehicle 100 and a forward direction of the parking space 305 (e.g., the vehicle 100 being straight forward in the parking space 305 is 0°, and the vehicle 100 being reversed in the parking space 305 is 180°).

The default parking pose 320 is the parking pose used by the autonomous parking feature in the absence of the determinations described below. The default parking pose 320 may be defined by the operation of the autonomous parking feature. For example, the default parking pose 320 may be the parking pose without consideration of the occupancy status of the vehicle 100, the stored preferences of the operator, and/or environmental or contextual features outside of the parking space 305. The default parking pose 320 may include the vehicle 100 being laterally centered in the parking space 305. In other words, a distance from a left side of the vehicle 100 to a left edge of the parking space 305 may be substantially equal to a distance from a right side of the vehicle 100 to a right edge of the parking space 305. The default parking pose 320 may include the vehicle 100 being longitudinally centered in the parking space 305. In other words, a distance from a front bumper of the vehicle 100 to a front edge of the parking space 305 may be substantially equal to a distance from a rear bumper of the vehicle 100 to a rear edge of the parking space 305. The default parking pose 320 may include the vehicle 100 being parked in a front-first direction in the parking space 305. For a perpendicular or diagonal parking space 305, the front-first direction occurs when the vehicle 100 drives forward into the parking space 305. For a parallel parking space 305, the front-first direction occurs when the orientation of the vehicle 100 matches the direction of travel in the lane adjacent to the parking space 305.

The target parking pose 315 is defined relative to the default parking pose 320 in the parking space 305. The determination of the target parking pose 315 is described in more detail below. The target parking pose 315 represents any deviations from the default parking pose 320. For example, the target parking pose 315 may include the vehicle 100 being laterally shifted by a lateral offset from the default parking pose 320 (e.g., as shown in FIGS. 3A-B and 3E). The lateral offset is a distance to the right or left from the default parking pose 320. The lateral offset has a direction (either left or right relative to the vehicle 100) and a magnitude (a length of the distance, such as 2 feet). For another example, the target parking pose 315 may include the vehicle 100 being longitudinally shifted by a longitudinal offset from the default parking pose 320. The longitudinal distance is a distance forward or rearward from the default parking pose 320. The longitudinal offset has a direction and a magnitude. For another example, the target parking pose 315 may include an orientation that is a selection of the front-first direction and the rear-first direction (e.g., as shown in FIGS. 3C-D).

The computer 105 is programmed to actuate components of the vehicle 100 according to the autonomous parking feature to navigate the vehicle 100 to a parking pose 315, 320 in the parking space 305. The parking pose may be the target parking pose 315 (determined as described below) or, in the absence of a target parking pose 315, the default parking pose 320. The autonomous parking feature may follow known techniques for driving the vehicle 100 so as to arrive at a particular pose. The autonomous parking feature may be an ADAS or may be part of an algorithm for autonomous or semi-autonomous operation of the vehicle 100 in multiple types of driving scenarios. For example, to navigate the vehicle 100 into a perpendicular parking space 305, the computer 105 may actuate the propulsion system 125 to move the vehicle 100 forward at a slow speed, may actuate the steering system 135 to turn the vehicle 100 toward the parking space 305 and straighten the vehicle 100 as the vehicle 100 moves into the parking space 305, and actuate the brake system 130 to stop at the parking pose. The autonomous parking feature navigates the vehicle 100 forward into the parking space 305 as just described upon the selection of the front-first direction, and the autonomous parking feature navigates the vehicle 100 in reverse into the parking space 305 upon the selection of the rear-first direction. Upon the selection of the rear-first direction, the vehicle 100 may first drive past the parking space 305 to a starting point in order to reverse into the parking space 305.

The computer 105 is programmed to, upon receiving a command to park the vehicle 100 in the parking space 305, determine the target parking pose 315. The computer 105 may determine, as parts of the target parking pose 315, the direction of the lateral offset, the magnitude of the lateral offset, the orientation of the vehicle 100 in the parking space 305, etc. As a general overview, the computer 105 may execute an algorithm for determining the target parking pose 315. The algorithm may be a rules-based algorithm, a machine-learning algorithm, or a combination of a rules-based algorithm and a machine-learning algorithm. The algorithm may take as inputs the occupancy status of the vehicle 100, proximity of any objects (such as fixed barriers 335 or other vehicles 340) to the parking space 305, the stored preferences of the operator, and/or data related to interpreting the stored preferences such as a current time or a current geographic location of the vehicle 100. The algorithm outputs the target parking pose 315 to the autonomous parking feature.

The algorithm may be a rules-based algorithm. For example, the algorithm may be a decision tree. The decision tree includes a plurality of stages. The first stage may have a root decision node with branches corresponding to options for that decision node, and each subsequent stage may have a decision node at each branch with further branching corresponding to the options for the respective decision node, ending in end nodes at the final stage. Each end node defines a target parking pose 315. The decision nodes at each stage may correspond to one of the inputs to the algorithm, such as occupancy status (whether more occupants 235 are on one side of the vehicle 100 than the other, whether a child 325 in a child seat 330 is present, etc.), whether an object such as a fixed barrier 335 or a second vehicle 340 is bordering the parking space 305, etc. To execute the decision tree, the computer 105 selects a branch from the root decision node according to the inputs, proceeds to the decision node on the selected branch, selects a branch from that decision node according to the inputs, and repeats until an end node is reached. The target parking pose 315 for that end node is then the output of the decision tree.

Alternatively, the rules-based algorithm may be a set of conditions paired with respective target parking poses 315. Each condition may be specified according to the inputs. For example, a first condition may be {no objects bordering the parking space 305, occupancy unbalanced toward the left side of the vehicle 100, no children 325 in child seats 330 present} (as shown in FIG. 3A), a second condition may be {no objects bordering the parking space 305, a child 325 is present in a child seat 330 on the right side of the vehicle 100} (as shown in FIG. 3B), etc. The computer 105 may determine which condition from the set of conditions is satisfied and then output the target parking pose 315 paired with the satisfied condition. The conditions may be prioritized in case more than one condition is satisfied, or the conditions may be defined such that at most one condition may be satisfied at a time. The computer 105 may output the default parking pose 320 as the target parking pose 315 in response to no conditions being satisfied.

The algorithm may be a machine-learning algorithm. The machine-learning algorithm may be trained to output a target parking pose 315 consistent with how the operator would manually park the vehicle 100 in that situation or with how operators generally would manually park the vehicle 100 in that situation. The machine-learning algorithm may be any suitable classification algorithm, such as support vector machines (SVM), nearest neighbors, etc. The machine-learning algorithm may be trained using supervised learning and/or reinforcement learning. The training data for supervised learning may include a set of parking scenarios and ground-truth target parking poses for the respective scenarios. Each parking scenario may be defined by the occupancy status of the vehicle 100, the proximity and type of any objects adjacent to or bordering the parking space 305, a current time, and a current geographic location of the vehicle 100. The training data for reinforcement learning may include the parking scenarios that the vehicle 100 experiences, paired with feedback provided by the operator when the vehicle 100 parks in those parking scenarios.

The algorithm may be a combination of a rules-based algorithm and a machine-learning algorithm. The computer 105 may execute the rules-based algorithm in certain circumstances and the machine-learning algorithm in other circumstances. For example, the computer 105 may determine whether the machine-learning algorithm is trained for the parking scenario that the vehicle 100 is currently experiencing. If so, the computer 105 may execute the machine-learning algorithm. Otherwise, the computer 105 may execute the rules-based algorithm.

With reference to FIG. 3A, the computer 105 may determine the target parking pose 315 based on the occupancy status, specifically, which seats 205 of the vehicle 100 are occupied. The computer 105 may classify one lateral side of the vehicle 100 (i.e., the left side or the right side) as a preferred side in response to the preferred side having more occupants 235 than the nonpreferred side or in response to the nonpreferred side lacking any occupants 235. The classification of a side as preferred may be instantiated in the algorithm for determining the target parking pose 315 described above. The computer 105 may determine the lateral offset of the target parking pose 315 to provide more space on the preferred side of the vehicle 100.

With reference to FIG. 3B-C, the computer 105 may determine the target parking pose 315 based on whether any of the seats 205 are occupied by a child 325 in a child seat 330 or by a full-size occupant 235. The computer 105 may determine whether any of the seats 205 are occupied by a child 325 in a child seat 330 and, if so, which lateral side of the vehicle 100 is the child 325 on. A lateral side of the vehicle 100 that includes a child 325 in a child seat 330 is designated as a preferred side of the vehicle 100. The classification of a lateral side as preferred may be instantiated in the algorithm for determining the target parking pose 315 described above. The computer 105 may determine the lateral offset of the target parking pose 315 to provide more space on the preferred side of the vehicle 100, as shown in FIG. 3B. Alternatively or additionally, the computer 105 may determine the orientation of the target parking pose 315 (e.g., for a parallel parking space 305) such that the preferred side of the vehicle 100 is adjacent to a curb, as shown in FIG. 3C.

With reference to FIGS. 3D-E, the computer 105 may determine the target parking pose 315 based on the proximity of an object to the parking space 305. For example, the object may be a fixed barrier 335 adjacent to the parking space 305, as shown in FIG. 3D. For another example, the object may be a second vehicle 340 parked in a second parking space 310 adjacent to the first parking space 305, as shown in FIG. 3E. The computer 105 may determine whether the object is bordering the parking space 305 or is within a threshold distance of the parking space 305 (e.g., based on data from the sensors 115 such as radar, lidar, or ultrasonic sensors). The threshold distance may be chosen to indicate that the object is close enough to possibly block doors 230 of the vehicle 100 from fully opening. The computer 105 may, in response to the object being within the threshold distance from the parking space 305, determine the orientation of the target parking pose 315 such that the preferred side of the vehicle 100 faces away from the object, as shown in FIG. 3D. The computer 105 may, in response to the object being within the threshold distance from the parking space 305 and the preferred side facing the object, determine the lateral offset of the target parking pose 315 to provide more space on the preferred side of the vehicle 100, as shown in FIG. 3E.

The computer 105 is programmed to determine the target parking pose 315 based on the stored preference of the operator of the vehicle 100 from a previous trip of the vehicle 100, as will be described below. The memory of the computer 105 may store a plurality of the stored preferences. Each stored preference is a target parking pose 315 paired with circumstances in which the target parking pose 315 should be used. For example, stored preferences may be paired with respective stored times and/or stored geographic location. The stored time may be a time of day and possibly day(s) of the week. Alternatively or additionally, stored preferences may be paired with other inputs described above, such as the occupancy status.

The computer 105 may be programmed to receive the stored preference from the operator of the vehicle 100 during the previous trip. The computer 105 may receive an input specifying the stored preference via the user interface 140. For example, the operator may directly input the stored preference, such as through settings available through the user interface 140. The computer 105 may be programmed to display a prompt with choices to the operator (e.g., within a menu structure of settings) and then receive a selection of one of the choices entered in response to the prompt. The operator may be able to enter, for example, the time or geographic location to store. The stored preference may be stored as part of the rules-based algorithm. For example, the stored preference may be stored as a decision node in the decision tree or as a condition in the set of conditions.

For another example, the operator may directly input the stored preference as feedback to use for reinforcement learning. The computer 105 may output a prompt via the user interface 140 in response to parking the vehicle 100 with the autonomous parking feature. The prompt may ask, with respect to the target parking pose 315 that the vehicle 100 is currently at, whether adjustments should be made, such as a greater magnitude for the lateral offset, a change in the orientation, etc. The preference is thus stored as feedback for the reinforcement learning of the algorithm for determining the target parking pose 315. The stored time and stored geographic location may be the time and geographic location at which the computer 105 receives the feedback.

For another example, the computer 105 may, in response to the operator parking the vehicle 100 manually, store the parking pose along with the current time and current geographic location as the stored preference. The computer 105 may determine the parking pose based on data from the sensors 115 indicating the boundaries of the parking space 305. The stored preference may be used as feedback for reinforcement learning of the machine-learning algorithm described above.

The computer 105 is programmed to determine the target parking pose 315 based on the stored preference of the operator of the vehicle 100 from the previous trip of the vehicle 100. For example, the stored preference may be stored in the algorithm for determining the target parking pose 315 (e.g., as a decision node or condition in the rules-based algorithm or as feedback for reinforcement learning of the machine-learning algorithm), and the computer 105 may later execute the algorithm for determining the target parking pose 315. The computer 105 may determine the target parking pose 315 based on the current time or the current geographic location of the vehicle 100. For example, the computer 105 may determine the target parking pose 315 according to the stored preference that is paired with the stored time matching the current time, or the computer 105 may determine the target parking pose 315 according to the stored preference that is paired with the stored geographic location matching the current geographic location (by executing the algorithm that includes the stored preference).

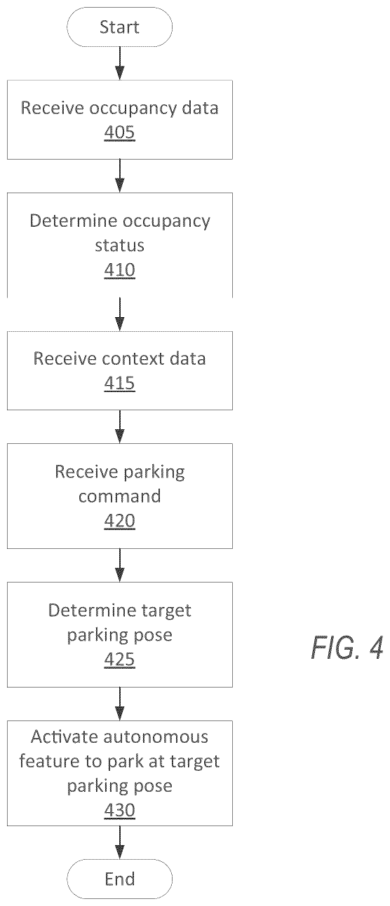

FIG. 4 is a flowchart illustrating an example process 400 for parking the vehicle 100 in the parking space 305. The memory of the computer 105 stores executable instructions for performing the steps of the process 400 and/or programming can be implemented in structures such as mentioned above. As a general overview of the process 400, the computer 105 receives data from the occupancy sensors 120, determines the occupancy status, receives data from the sensors 115, receives a command to park the vehicle 100 in the parking space 305, determines the target parking pose 315, and actuates components of the vehicle 100 according to the autonomous parking feature to navigate the vehicle 100 to the target parking pose 315.

The process 400 begins in a block 405, in which the computer 105 receives data from the occupancy sensors 120, as described above.

Next, in a block 410, the computer 105 determines the occupancy status of the vehicle 100, as described above.

Next, in a block 415, the computer 105 receives data from the sensors 115. The data may indicate the surroundings of the vehicle 100, including the parking space 305 and any objects near the parking space 305, as described above. The data may indicate the current geographic location of the vehicle 100.

Next, in a block 420, the computer 105 receives the command to park the vehicle 100 in the parking space 305 (e.g., via the user interface 140), as described above.

Next, in a block 425, upon receiving the command to park the vehicle 100 in the parking space 305, the computer 105 determines the target parking pose 315 in the parking space 305, based on the occupancy status from the block 410 and the data from the sensors 115 from the block 415, as described above.

Next, in a block 430, the computer 105 actuates components of the vehicle 100, such as the propulsion system 125, brake system 130, and steering system 135, according to the autonomous parking feature to navigate the vehicle 100 to the target parking pose 315, as described above. After the block 430, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Terms such as “front,” “forward,” “longitudinal,” “back,” “rear,” “rearward,” “left,” “right,” “lateral,” “upward,” “downward,” “vertical,” etc., are understood relative to the vehicle 100. The adjectives “first” and “second” are used throughout this document as identifiers and are not intended to signify importance, order, or quantity. “Substantially” as used herein means that a dimension, time duration, shape, or other adjective may vary slightly from what is described due to physical imperfections, power interruptions, variations in machining or other manufacturing, measurement uncertainty, etc. Use of “in response to,” “upon determining,” “upon receiving,” “upon parking,” “upon selection,” etc. indicates a causal relationship, not merely a temporal relationship. Many modifications and variations of the present disclosure are possible in light of the above teachings, and the disclosure may be practiced otherwise than as specifically described.

1. A computer comprising a processor and a memory, the memory storing instructions executable by the processor to:
upon receiving a command to park a vehicle in a parking space and contingent on a stored time of day that is paired with a stored preference matching a current time of day, determine a target parking pose in the parking space based on the stored preference, the stored preference being from an operator of the vehicle from a previous trip of the vehicle, the target parking pose being defined relative to a default parking pose in the parking space; and
actuate components of the vehicle according to an autonomous parking feature of the vehicle to navigate the vehicle to the target parking pose.

2. (canceled)

3. (canceled)

4. The computer of claim 1, wherein the stored preference is paired with a stored geographic location, and the instructions to determine the target parking pose include instructions to determine the target parking pose according to the stored preference that is paired with the stored geographic location matching a current geographic location.

5. The computer of claim 1, wherein the instructions to determine the target parking pose include instructions to determine the target parking pose based on an occupancy status of the vehicle.

6. The computer of claim 1, wherein the instructions to determine the target parking pose include instructions to determine the target parking pose based on which seats of the vehicle are occupied.

7. The computer of claim 1, wherein the instructions to determine the target parking pose include instructions to determine the target parking pose based on whether a seat of the vehicle is occupied by a child in a child seat or a full-size occupant.

8. The computer of claim 1, wherein the instructions to determine the target parking pose include instructions to determine the target parking pose based on a proximity of an object to the parking space.

9. The computer of claim 8, wherein the object is a fixed barrier adjacent to the parking space.

10. The computer of claim 8, wherein the object is a second vehicle parked in a second parking space adjacent to the parking space.

11. The computer of claim 1, wherein the parking space is a perpendicular parking space, the default parking pose includes the vehicle being laterally centered in the parking space, and the target parking pose includes the vehicle being laterally shifted by a lateral offset from the default parking pose.

12. The computer of claim 11, wherein the instructions to determine the target parking pose include instructions to determine a direction of the lateral offset.

13. The computer of claim 11, wherein the instructions to determine the target parking pose include instructions to determine a magnitude of the lateral offset.

14. The computer of claim 1, wherein the default parking pose includes the vehicle being parked in a front-first direction in the parking space, and the instructions to determine the target parking pose include instructions to determine an orientation of the vehicle in the parking space, the orientation being a selection of the front-first direction and a rear-first direction.

15. The computer of claim 14, wherein the autonomous parking feature navigates the vehicle forward into the parking space upon the selection of the front-first direction, and the autonomous parking feature navigates the vehicle in reverse into the parking space upon the selection of the rear-first direction.

16. A method comprising:
upon receiving a command to park a vehicle in a parking space and contingent on a stored time of day that is paired with a stored preference matching a current time of day, determining a target parking pose in the parking space based on the stored preference, the stored preference being from an operator of the vehicle from a previous trip of the vehicle, the target parking pose being defined relative to a default parking pose in the parking space; and
actuating components of the vehicle according to an autonomous parking feature of the vehicle to navigate the vehicle to the target parking pose.

17. (canceled)

18. (canceled)

19. The method of claim 16, wherein the stored preference is paired with a stored geographic location, and determining the target parking pose includes determining the target parking pose according to the stored preference that is paired with the stored geographic location matching a current geographic location.

20. The method of claim 16, wherein determining the target parking pose includes determining the target parking pose based on an occupancy status of the vehicle.

21. The computer of claim 1, wherein the instructions to determine the target parking pose based on the stored preference include instructions to determine the target parking pose based on the stored preference contingent on a stored day of the week that is paired with the stored preference matching a current day of the week.

22. The computer of claim 1, wherein the instructions further include instructions to receive the stored time of day to pair with the stored preference by the operator entering the stored time of day.

23. The computer of claim 1, wherein the stored time of day is a time of day at which feedback defining the stored preference was received.
